(19) United States
(12) Patent Application Publication
(10) Pub. No.: US 2019/0279304 A1
(43) Pub. Date: Sep. 12, 2019

(54) SYSTEM, METHOD, AND COMPUTER PROGRAM PRODUCT FOR VALUATING SPACE WEATHER-BASED FINANCIAL INSTRUMENTS

(71) Applicants: Stephan Unger, Kritzendorf (AT); Johann Lemmerer, Irdning-Donnersbachtal (AT)

(72) Inventors: Stephan Unger, Kritzendorf (AT); Johann Lemmerer, Irdning-Donnersbachtal (AT)

(21) Appl. No.: 15/915,784

(22) Filed: Mar. 8, 2018

(51) Int. Cl. G06Q 40/06; G06Q 30/02; G01W 1/10

(52) U.S. Cl. CPC G06Q 40/06; G01W 1/10; G06Q 30/0201; G06Q 30/0206

(57) ABSTRACT

A system and method for evaluating space weather-based derivatives, such as futures, options, swaps, and the like, with payout depending on solar activity. The system includes space weather data, financial databases and a central processing trading server that is accessible via a plurality of internal and external workstations.

### CROSS-REFERENCE TO OTHER APPLICATIONS

The following applications of common assignee are related to the present application: “System, method, and computer program product for valuating weather-based financial instruments”, Ser. No. 09/168,276, filed Oct. 8, 2008, now U.S. Pat. No. 6,418,417.

“Real-Time Auction of Cloud Computing Resources”, Ser. No. 12/247,654, filed Sept. 25, 2008, now U.S. Pat. 20100076856 A1.

### BACKGROUND OF THE INVENTION

### 1. Field of the Invention

The present invention relates to financial pricing tools and more particularly to the valuation and trading of space weather-based financial Instruments such as derivatives and the like.

### 2. Related Art

For the description of the related art we refer to the definition given in (Corby and Fox, 2012): “In today's financial markets, the use of financial instruments known as “derivatives” have exponentially grown and is now common place. A derivative is an investment vehicle whose value is based on the value of another security or underlying asset. That is, a derivative is essentially a financial instrument that is derived from the future movement of something that cannot be predicted with certainty.

By the late 2000's the Office of the Comptroller of the Currency estimates that commercial banks in the United States alone, held over twenty trillion dollars worth of derivative-based assets. Common examples of derivatives include futures contracts, forward contracts, options, and swaps, all of which are briefly explained below.

Forward and futures contracts are standardized, transferable agreements, which may be exchange-traded, to buy or sell a commodity (e.g., a particular crop, livestock, oil, gas, etc.). These contracts typically involve an agreed-upon place and time in the future between two parties.

Options contracts are agreements that may be exchange-traded, among two parties that represent the right to buy or sell a specified amount of an underlying security (e.g., a stock, bond, futures contract, etc.) at a specified price within a specified time. The parties of options contracts are purchasers who acquire “rights,” and sellers who assume “obligations.” Further, a “call” option contract is one giving the owner the right to buy, whereas a “put” option contract is one giving the owner the right to sell the underlying security. There is typically an up-front, non-refundable premium that the buyer pays the seller to obtain the option rights.

Swaps allow entities to exchange variable cash flows for fixed payments. They are similar to options but no premium (i.e., up-front money) is paid to obtain the rights. It is essentially an outright trade based on the expected movement of the price of the derivative's underlying commodity.

Derivatives are typically used by institutional investors to increase overall portfolio return or to hedge or revoke portfolio risks. Derivatives are also frequently used by banks, companies, organizations, and the like to protect against market risks in general. For example, utility companies, satellite operators or electricity providers may be interested in protecting against peaks in solar activity. Derivatives help in managing risks by allowing such operators, companies, organizations, and the like to divide their risk into several pieces that may be passed off to other entities who are willing to shoulder the risk for an up-front fee or future payment stream.

Derivatives, being financial instruments, may be traded among investors as are stocks, bonds, and the like. Thus, in order to trade derivatives, there must be a mechanism to price them so that traders may exchange them in an open market. The relationship between the value of a derivative and the underlying asset are not linear and can be very complex. Economists have developed pricing models in order to valuate certain types of derivatives. Risks in relying on any model includes errors in the model's underlying assumptions, errors in calculation when using the model, and failure to account for variables (i.e., occurrences) that may affect the underlying assets.” (Corby and Fox, 2012) When considering the latter risk -failure to account for occurrences that may affect price-space weather and its effects have been historically overlooked. That is, space weather, and more specifically future space weather, has not been included as a formal variable in pricing models.

An overview of weather derivatives has been given in (Corby and Fox, 2012), who describe the usual application of weather derivatives with respect to “cooling and heating degree-days”.

There exist no models, which consider space weather as an input for pricing financial instruments for risk management purposes. Long-term predictions of space weather events such as solar eruptions and of their impacts on the Earth are barely impossible to make. Thus satellite operators, aviation companies and electricity providers have been operating in the “blind” without knowledge of future space weather conditions. Therefore the importance of having the possibility to hedge against the financially risk of being exposed to unpredictable solar activity is given.

Further, as is well known in the relevant art(s), mean reverting processes are mostly used in describing natural phenomena. As such, the Ornstein-Uhlenbeck process, Heston or Vasicek model are usually used to price options. Spatial events such as solar eruptions (e.g., coronal mass ejections; CMEs) or solar flares can best be measured using inverse transform sampling. Therefore, this method is being incorporated within this invention into an Ornstein-Uhlenbeck, Heston or Vasicek framework.

### SUMMARY OF THE INVENTION

The present invention is a system, method, and computer program product for valuating (and thus, processing and trading) space weather-based financial instruments and/or financial instruments that are impacted in some manner by space weather. The method preferably involves specifying a start date and maturity date for the financial instrument. The value of a space weather derivative refers to the space weather condition in the Earth's magnetosphere. A financial database may then be accessed so that a risk-free rate can be specified. A space weather history database is then accessed to obtain historic space weather information for the Earth's magnetosphere during the period between the start date and the maturity date. A pricing model can then be applied to obtain a value for the space weather-based financial instrument using the historical space weather information and the risk-free rate.

The system for valuating a space weather-based financial instrument of the present invention includes a space weather history database that stores historical space weather information regarding the disturbance of the magnetosphere.

The system may also include a financial database that stores information in order to calculate a risk-free rate. In order to access the databases and valuate financial instruments, a trading server is included within the system. The trading server provides the central processing of the system by applying a pricing model, and is responsive to a plurality of internal and external workstations that allow users, via a graphical user interface, to access the trading system.

One advantage of the present invention is that all space weather derivatives can more easily and confidently be priced when accounting for historic and current space weather.

Another advantage of the present invention is that information and data sets can be provided that enable traders to identify and capitalize on space weather-driven market fluctuations.

Further features and advantages of the invention as well as the structure and operation of various embodiments of the present invention are described in detail below with reference to the accompanying drawings.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram representing the system architecture of the present invention;

FIG. 2 is a flowchart representing the preferred operation of the present invention;

FIG. 3 depicts a preferred space-weather history database used by the present invention;

FIG. 4 shows a graphical user interface screen where the user enters the parameters to price a space weather derivative;

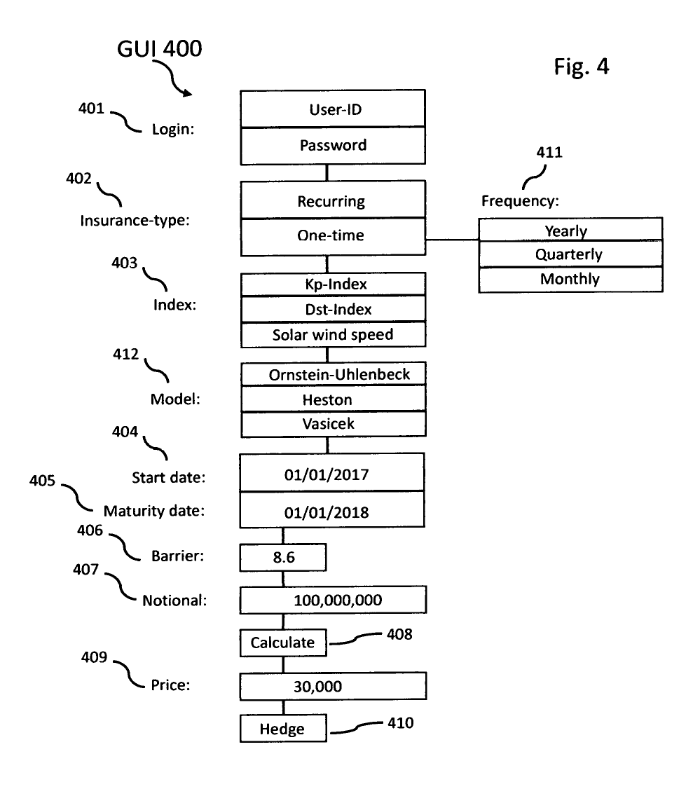

FIG. 5 explains the pricing model used in the pricing engine running on the cloud based pricing server;

### DETAILED DESCRIPTION OF THE PREFERRED EMBODIMENTS

TABLE OF CONTENTS

```
I. Overview
  A. Overview of space weather derivatives
  B. Overview of current invention
II. System Architecture
  A. System Architecture Overview
  B. Space Weather History Database
  C. Market Database
  D. Price Database
III. The Pricing model
IV. General System Operation
  A. Inputs
  B. Processing and Output
V. Detailed Example of System Operation
VI. The pricing engine
VII. Conclusion
```

### I Overview

A. Overview of space weather derivatives

The Sun, our host star, provides the energy needed to ensure life on Earth. However, energy outbursts on the Sun towards the Earth can damage satellites and cause failures in GNSS (global navigation satellite system) or telecommunication systems, endanger astronauts in manned spaceflights and even lead to large-scale electrical power outages by inducing currents in conductors and melting electricity transformers.

‘Space weather’ describes the conditions on the Sun, in the solar wind and the Earth's magneto-, iono- and thermosphere.

Harmful effects of Space Weather on the Earth and its environment are initiated by explosive events on the Sun:

Flares (X-ray to UV flux reach the Earth's upper atmosphere in eight minutes), solar energetic particles (SEPs, reaching the Earth in about 10 minutes) and coronal mass ejections (CMEs, reaching the Earth in 18 hours to four days).

The Sun, is a G2 type star that rotates differentially, around 25 days at the equator and around 30 days at the poles, and twists the magnetic field lines, which are generated by the solar dynamo. This twisting leads to an increase and decrease in magnetic field strength. The magnetic field changes its sign every 11 years, forming the solar cycle. The period of strong magnetic field strength is characterized by magnetic field lines pushing through the surface of the Sun, the photosphere, visible as sunspots. In periods of low solar activity, only a few sunspots are visible.

The solar wind is described as a particle stream, which is released from the upper solar atmosphere and consists of electrons, protons and alpha particles. The interplanetary magnetic field is embedded in the solar wind plasma. The fast solar wind has a typical velocity of 750 km/s and originate from coronal holes, regions of open field lines. Geomagnetic storms are driven by high speed streams and tend to periodically occur within a 27-day cycle, which is the solar rotation. As a result, an acceleration of electrons in the radiation belt to high energies happens one or two days later (Baker et al. 1998).

Outbursts of plasma and magnetic flux are ejected from the corona, the outermost layer of the solar atmosphere, and hence are called ‘coronal mass ejections—CMEs’ as well as ‘solar storms’. The CMEs are accelerated to thousands of km/s and are transported via magnetic field lines in the interplanetary space and the near-Earth environment. CMEs that are launched with a speed >400 km/s drive a shock wave (Schwenn 1983). If this shock and the following ejecta cloud hits the Earth it interacts with the Earth's magnetic field and geomagnetic effects occur (geomagnetic storms, e.g. Zhang et al. 2007, Gosling et al. 2000). When a CME hits the Earth's magnetosphere, it stretches the magnetic field lines away from the Sun side. Magnetic field lines might break due to magnetic reconnection and accelerate protons and electrons in lower atmospheric layers of the Earth. This results in a reconfiguration of the Earth's magnetic field lines and influences the Earth's magnetosphere. The energization of the magnetospheric system can be visible at night as auroras.

Solar flares strongly contribute to space weather effects on the Earth's environment. Flares are the visible manifestations of the release of high amounts of energy (10²⁴ kJ) stored in the solar corona, which result from twisted magnetic field lines (Kane, 2005). CMEs are also sometimes produced by this energy release. The sudden flash of brightness releases electromagnetic radiation within seconds to minutes. They cover a wavelength range from kilo metric radio waves to X-rays. The EUV radiation is absorbed by the Earth's atmosphere. It causes heating and expansion instantaneously, which leads to a drag of satellites that cruise in low orbits. Solar flares occur around sunspots in active regions, associated with a complex magnetic field configuration (Schwenn 2006).

SEPs consist of ions and electrons and their release is associated with flares and coronal shock waves. The energy of SEPs reaches from keV to GeV that arrive the Earth a few minutes after a light flash. They consist of protons, electrons and high-energy ions with energy ranging from a few tens of keV to GeV and reaching speeds up to 50% of the speed of light.

The geo-effectiveness is the result of geomagnetic storms caused by inter-planetary magnetic structures. Geomagnetic storms occur when the negative directed component of the interplanetary magnetic field interacts with the Earth's magnetic field. Geomagnetic storms typically proceed counterclockwise around the magnetosphere and start around midnight (Ferguson et al. 2015).

The maximum geo-effectiveness of a magnetic storm occurs, when a CME is launched near the center of the Sun on a trajectory that has an impact on the magnetic field of the Earth, is faster than 1000 km/s, and has a strong Bz component.

The geo-effectiveness is measured and characterized using several indices. The Kp-index measures a 3 hour disturbance in the Earth's magnetic field and the Dst-index measures the hourly Kp-index averaged from four observatories. The Kp-index forecasts are used for prediction of Aurora, MeV electron fluxes at geosynchronous orbits, charging events and spacecraft anomalies. The Kp-index is a weighted average of the K-index. The K-index indicates the geomagnetic activity measuring disturbances in the horizontal component of the Earth's magnetic field. These measurements are quantified with an integer range from 0 to 9, where >5 indicates a geomagnetic storm.

Riley (2012) assumed a power law distribution for many space weather parameter, which can also be extrapolated to extreme order of events to estimate their probabilities. By extrapolation from smaller events he found the occurrence rate of large event (Carrington event; -Dst >850 nT) at ^{˜}1.2 per century, which is a 12% probability for the occurrence in the next decade. A Dst value of around 700 or 800 nT already has devastating effects on the human technology. Love et al. (2015) found, using maximum likelihood fits for extrapolation, that the possibility of the occurrence of a magnetic storm like the 1989 event (-Dst>589 nT) per century is about 4.03 (95% confidence interval of [2.01,6.84]) and of a Carrington event is about 1.13 with a 95% confidence interval of [0.42,2.41].

Kataoka (2013) considered the sunspot number for calculating the occurrence rate of a super storm in the next decade. The author found that the number of intense storm (negative H component excursion of D>100 nT) divided by the solar cycle length is clearly proportional to the maximum sunspot number. Taking the predictive value for the maximum sunspot number of cycle 24 (current cycle, will be determined in a few years) of 84 and the probability of a Carrington storm (dH=1500nT) to occur in the next decade, is estimated by Kataoka (2013) to be 6%.

Speedwell (2015) lists several points, which indicate the superiority of weather derivatives over ordinary insurances:
Conventional insurance contracts are indemnification based and require that a loss be demonstrated. A weather derivative pays out irrespective of the actual impact of weather on a company.
Insurance contracts often tend to cover high risk, low probability events whereas weather derivatives may also cover lower risk, higher probability scenarios.
With a weather derivative, it is possible to design a payout to be in proportion to the magnitude of the adverse weather phenomena.
Weather derivatives are index-based ensuring total transparency. Unlike conventional insurance, there is no loss-adjustment process and settlement is therefore usually quicker.

Weather derivatives can be structured as swaps, options or futures.

According to Cao (2003) there are five essential elements to every weather contract: (a) the underlying index, (b) the period over which the index accumulates, typically a season or month, (c) the weather station that reports daily maximum and minimum temperatures, (d) the dollar value attached to each move of the index value, and (e) the strike of the underlying index estimation.

Large solar flares and CMEs can produce large quantities of superfast solar wind flows, X-rays, gamma rays, energetic particles and UV bursts, that have extreme effects on the Earth's environment (Baker 2000). It is clear that solar terrestrial coupling extends at least into the lower thermosphere and mesosphere of the Earth. Callis et al. (1998a,b) suggest that solar terrestrial coupling also extends into the Stratosphere.

Like other weather phenomenon such as earthquakes, hurricanes or tornadoes, space weather is difficult to predict (Petrovay, 2010). In order to capture the effects of solar activity we focus on the Kp-index to classify the severity of solar phenomena that are visible as geomagnetic storms. The 11 year cycle of the Sun, which is also visible in the number of Sunspots, have imminent impact on the magnetic field of the Earth, on directly exposed instruments, machines or satellites in the orbit. Depending on the severity of a geomagnetic storm, GPS, telecommunication and information systems might break down or get damaged. Such storms might even have severe impact on electricity providers, TV and radio stations as well as on electronic devices used in transportation, power plants, hospitals and other neuralgic places (e.g. Baker, 2000).

The magnetosphere and ionosphere respond to the forces of the solar wind and solar phenomena, which is measured by geomagnetic indices like the Kp-index. We capture this response to the solar activity, measured by the Kp-index, by inverse transformation sampling since sudden spikes are not predictive. We base our sample size on the historic Kp-values since 1913.

Space weather derivatives can be regarded to a class of weather derivatives such as temperature or rainfall.

In order to determine a fair value of a weather derivative, the payoff is usually a function of a weather index. For example, the index used could be millimeters of rainfall or cumulative temperature using observations from a single weather reference site or a basket of sites.

For pricing a space weather derivative, we need to take the geomagnetic risk into account which might emerges out of solar phenomena:
Geomagnetic Storm risk: Is measured by the Kp-index. The Kp-index ranges from 0 to 9 where a value of 0 means that there is very little geomagnetic activity and a value of 9 means extreme geomagnetic storming. Geomagnetic storms are classified from G1(minor) to G5(extreme). At a Kp index of 5 (Kp=5), power grid fluctuations can occur and minor impact on satellite operations is possible. A geomagnetic strom(Kp=8) can already cause widespread voltage control problems. Furthermore, protective system problems can occur as well as some grid systems may experience complete collapse or blackouts.

### B. Overview of Current Invention

The Kp index (originating from “planetarische Kennziffer”) is used to measure and monitor the variability of the Earth's magnetic field. It indicates the severity of the disturbances in the magnetic field and is used for studying the underlying causes of geomagnetic activity and consequences e.g. to power systems (e.g. Boteler 2001).

The Kp index is used by the U.S. Federal Aviation Administration, by geological surveying crews to preventing survey errors, by Boeing and the ISS to prevent damage, and by NASA for mission planning.

The Kp index represents the mean value of the geomagnetic disturbance levels in two horizontal magnetic field components, which are monitored by 13 ground-based magnetic observatories (Menvielle and Berthelier 2001; Potsdam homepage link). Local disturbances are determined by measuring the difference between the lowest and highest values during a 3-hour time interval for the most disturbed horizontal magnetic field component. This value is converted into the local K-index. A quiet-day variation pattern is removed from the magnetogram, followed by calculating the frequency of occurrence of different sizes of magnetic disturbances by taking the values according to a quasi-logarithmic scale. For each observatory, the local K-index has an annual cycle of daily variations. To eliminate these effects and to determine a standardized index for each station, conversion tables are generated and applied to the values of the 13 stations. The Kp index has been published since its introduction by Bartels in 1949 and extended backwards to 1932, by the Institut fuer Geophysik der Universitaet Goettingen. The Kp index and additional information are available at the GF2 German research centre for Geosciences in Potsdam, Germany and a review of the Kp index is given by Rostoker (1972).

The global Kp index is expressed in a scale of thirds (Table 1).

TABLE 1
Kp-index

| | Kp in | Geomagnetic | |
|---|---|---|---|
| Kp | decimals | latitude | Auroral activity |
| 0o | 0.0 | 66.5° | Quiet |
| 0+ | 0.33 | | Quiet |
| 1− | 0.67 | | Quiet |
| 1o | 1 | 64.5° | Quiet |
| 1+ | 1.33 | | Quiet |
| 2− | 1.67 | | Quiet |
| 2o | 2 | 62.4° | Quiet |
| 2+ | 2.33 | | Quiet |
| 3− | 2.67 | | Unsettled |
| 3o | 3 | 60.4° | Unsettled |
| 3+ | 3.33 | | Unsettled |
| 4− | 3.67 | | Active |
| 4o | 4 | 58.3° | Active |
| 4+ | 4.33 | | Active |
| 5− | 4.67 | | Minor storm |
| 5o | 5 | 56.3° | Minor storm |
| 5+ | 5.33 | | Minor storm |
| 6− | 5.67 | | Moderate storm |
| 6o | 6 | 54.2° | Moderate storm |
| 6+ | 6.33 | | Moderate storm |
| 7− | 6.67 | | Strong storm |
| 7o | 7 | 52.2° | Strong storm |
| 7+ | 7.33 | | Strong storm |
| 8− | 7.67 | | Severe storm |
| 8o | 8 | 50.1° | Severe storm |
| 8+ | 8.33 | | Severe storm |
| 9− | 8.67 | | Severe storm |
| 9o | 9 | 48.1° | Extreme storm |

The official, finalized Kp-index is updated twice a month and is published e.g. on the GFZ webpage.

This delay of publishing makes it difficult for space weather operations. Therefore, an algorithm was developed by Gehred et al. (2005) to calculate the nowcast Kp. The nowcast Kp index is taking real-time data from magnetometer stations into account to derive a near real-time Kp estimate. The nowcast Kp is available by NOAA and is produced by the United States Air Force (USAF) 55th Space Weather Squadron.

As shown in Snyder et al (1963), the Kp index is correlated with solar wind speed. The variability of the solar wind speed makes the prediction of the Kp index more difficult (Elliot, 2013).

The ability of neuronal network (NN) models to learn from cases and to build relationships between the Kp index and solar wind parameters are useful for space weather predictions. Models that predict the Kp index are developed e,g, by Boberg et al. (2000), Costello (1997) or Wing et al. (2005). Wing et al. (2005) introduced a forecasting method, which is based on use of Neural networks using the Kp nowcast, the upstream solar wind speed and density, the upstream interplanetary magnetic field magnitude and the Bz component. There exist also different forecasting methods, e.g. from Bala and Reiff (2012) that use solar wind-magnetosphere coupling functions, as a basis function to train a neural network.

The long uninterrupted record makes the Kp index ideal for studying space weather effects on e.g. the satellite drag. Therefore, the Kp index will play an important role in the near future.

### II System Architecture

### A. System Architecture Overview

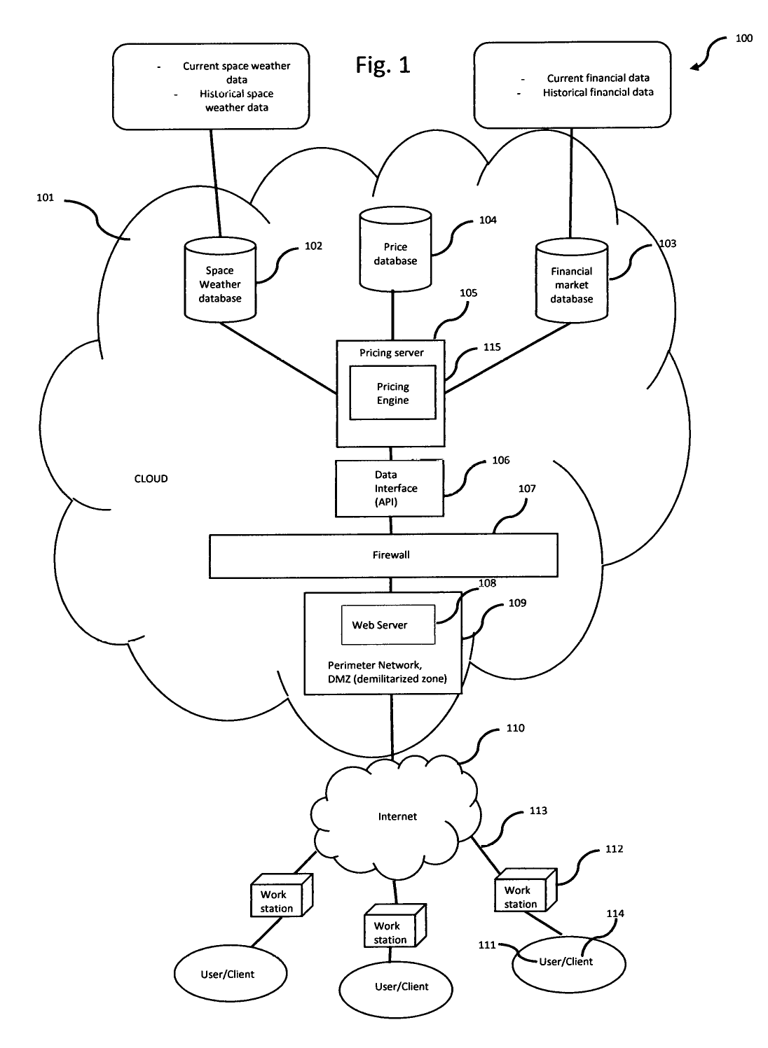

Referring to FIG. 1, a space weather trading system, according to embodiment of the present invention, is shown. It should be understood that the particular trading system 100 in FIG. 1 is shown for illustrative purposes only and does not limit the invention. Other implementations for performing the functions described herein will be apparent to persons skilled in the relevant art(s) based on the teachings contained herein, and the invention is directed to such other implementations. As will be apparent to one skilled in the relevant art(s), all components “inside” of the trading system 100 are connected and communicate via a communication medium such as a computer network. The system can therefore also be implemented using a cloud-based architecture 101. We base our cloud computing environment as well as the cloud based architecture on U.S. patent application No. 20100076856 A1, filed Sept. 25, 2008, entitled “ Real-Time Auction of Cloud Computing Resources”

The trading system 100 runs on a cloud-based architecture 101 which includes a space weather database 102, a financial market database 103 and a price database 104. The space weather database 102 includes current and historical space weather data such as Wing Kp-index from US Air Force Weather or “Planetarische Kennziffer” Kp-index Potsdam. The financial market database 103 includes current and historical financial data such as interest rates while the price database 104 stores all pricing data. The space weather database 102 provides the relevant input data to the pricing server 105, which calculates prices for hedging in the pricing engine 115. The output of the pricing server 105 is then routed and stored into the price database 104 as well as routed through the data interface (API) 106 to the web server 107. The web server 108 is contained in a perimeter network 109 in a so-called DMZ (demilitarized zone), separated from the internal network by a firewall 108. The firewall 108 serves as a secure connection and separation between the internal network and critical processing architecture 102-106, 115 on the one side and the web server 107 in its perimeter network 109 and the Internet 110 on the other side.

As is well-known in the relevant art(s), a Web server is a server process running on a server, which sends out web pages in response to Hypertext Transfer Protocol (HTTP) requests from remote browsers. The Web server 107 serves as the “front end” of the present invention. That is, the Web server 107 provides the graphical user interface (GUI) to users of the trading system 100 in the form of Web pages. Such users may access the Web server 107 via a plurality of workstations 112.

Several users 111 have access to the Internet 110 and can calculate prices online via the GUI by using their workstations 112, which transmit signals 113 to the web server 107.

### B. Space Weather History Database

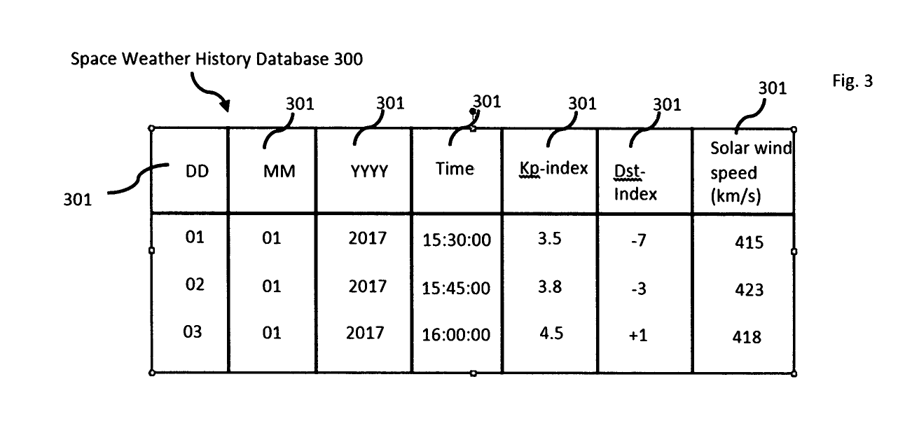

An example space weather history database 300 is shown in FIG. 3. The space weather history database 300 includes all relevant space weather and geomagnetic indices. The database 300 records for each day 301, month 302, year 303, and time 304 the value of the calculated Kp-Index 305, Dst-index 306 and solar wind speed 307, as well as the associated probability of a CME 308. The database 300 will be accessed by the pricing server 105, where the values of the calculated Kp-Index 305, Dst-index 306 and solar wind speed 307, as well as the associated probability of a CME 308 serve as inputs for the valuation of the space weather derivative. All the historic data is saved in the space weather database 102.

### C. Market Database

The market database 103 contains current as well as historic financial market data that is used by the pricing server 105. The market database 104 includes all worldwide current as well as historic interest rates, resp. risk-free rate. Such information, as will be apparent to one skilled in the relevant art(s), may include but is not limited to one or more of the Discount Rate, the Prime Interest Rate, the Treasury Bill rates, the Interbank Official Rates (LIBORs), the overnight rates and the like. The risk-free rate information within the market database 104 is necessary for discounting the future value of a space weather derivative to today's present value.

### D. Price Database

The price database 104 includes all historically priced values of space weather derivatives if they were closed. This means that the price database 104 does not save pricing attempts or simple try outs which might be used for pricing indication. Only prices with corresponding transaction are saved in the pricing database 104.

### III The Pricing Model

A possible market for space weather derivatives would be an incomplete market since the underlying variable, the solar activity and the effects of solar-terrestrial connection, is not tradable. Therefore we need to make use of a constant market price of risk, in order to obtain unique prices for space weather contracts.

Furthermore, we assume that we are given a risk free asset with constant interest rate r and a contract that for each Kp-index pays one unit of currency.

Thus, under a martingale measure Q, our price process X, characterized by the market price of risk A, satisfies the dynamics as follows.

We define the dynamics of the Kp-index as a mean reverting process following an Ornstein-Uhlenbeck process:

dX=a(X̅−X ₜ)dt+σdWₜ

where (Wₜ, t≥0) is Q-Wiener process, a defines the speed of mean reversion, X̅ₜ defines the long term Kp-index value, and X defines Kp-index value at time t, which is given by inverse transformation sampling. The returns of Xₜ−Xₜ₋₁ are log-normal distributed. For parameter estimation of a and a we refer to (Alaton et al. 2002).

The dynamics of the Kp-index, Xᵢ, are captured by inverse transform sampling:

Let

P(X=x^{k})=p^{k}, k=1,2, . . . , n,

with Σₖ₌₁ⁿp^{k}=1

be the probability mass function (PMF) of the Kp-index values, calculated by historical data with n values. Then the PMF of an end-of-day Kp-index value at time t is given by

P(X(t)=x^{k})=P(F(x^{k-1})≤U≤F(x^{k}),

with F(x^{t}) being the cumulative distribution function (CDF) of historical 3-hours intra-day Kp-index values at time t, calculated from the PMF and U, an uniform random variable between 0 and 1.

For an Ornstein-Uhlenbeck process considering inverse transformed sampled input variables, we get the following dynamics:

X(t)=X(0)e^{-at}+X̅(1−e^{-at})+σ∫₀^{t}e^{-a(t-s)},

where a is the speed of mean reversion, X̅ is the mean and a the volatility.

The same application, considering inverse transform sampling, applies to other mean-reverting processes.

The critical Kp-index value to orbital instruments and vehicles is Kp≥8. The larger the values the more severe and irreversible damage is caused. It suffices if a critical value just hit once. Therefore we need to price a one-touch digital option. The value of a cash-or-nothing binary option with payoff D, notional N, maturity T and barrier H is defined by

D=e^{∫}^{₀}^{^{τ}}^{τ}^{ₛ}^{ds}E_{Q}[N_{τ}1_{X≥H}]

for any stopping time τ≤T.

### IV. General System Operation

### A. Inputs

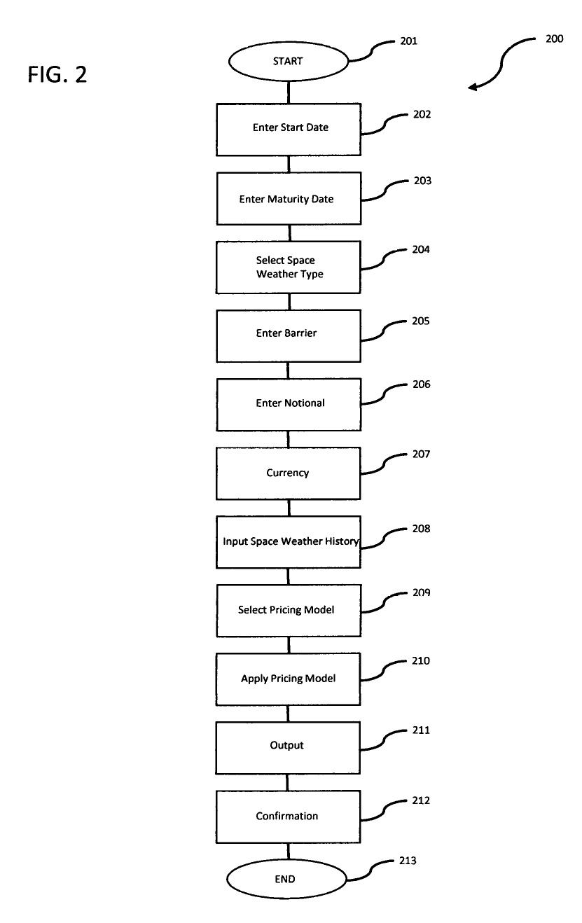

Referring to FIG. 2, the flowchart 200 shows the 11 steps of the pricing operation. The process starts 201 with a login into the processing service 101, followed by entering a start date 202 and a maturity date 203. The next step includes the selection of the space weather index type 204 such as Kp-index 305, Dst-index 306 or solar wind speed 307. Next step is to enter the barrier 205, the notional 206, which is the amount to be hedged, as well as the currency 207.

After the selection of the barrier 205, the notional 206 and the currency 207, the space weather database 102 is accessed and the space weather data is selected as an input for the space weather history 208. This input is used for the pricing model 503 which needs to be selected in the next step “select pricing model” 209. The selected pricing model 503 is then applied 210 and processed in the pricing engine 115. The pricing engine 115 then returns a price as an output 211 in the currency chosen in step 207. By confirmation 212 of the transaction price the process ends 213.

### B. Processing and Output

In step 208 the pricing engine 115 loads all relevant space weather history data for pricing the space weather derivatives according to the inputs 202, 203, 204, 205, 206 and 207. The information contains all historic space weather data of the Kp-index 305, Dst-index 306, solar wind speed 307 and probability of a CME 308. The pricing engine 115 uses all available historical data since space weather data has, unlike financial data, no biased relevance regarding priority of new historic data. Financial data overweighs new incoming information whereas space weather data has to take into account all available history.

For processing the historic space weather data, the pricing engine 115 also needs market data 103. The pricing server 105 then routes all relevant input into the pricing engine 115, which processes the input variables into the selected pricing model 209. The appropriate index 502 is selected by the user 111. According to the index selection 502, the pricing server 105 feeds the pricing engine 115 with the relevant data 305, 306, 307 or 308.

After processing the relevant input data the pricing engine 115 returns on a user's GUI 400 the inquired space weather derivative price 409. If the user 111 accepts the calculated price he can confirm the price by clicking on the hedge button 410. By clicking the hedge button 410 the calculated space weather derivative price turns into a transaction price which will be saved in the price database 104. Moreover by clicking the hedge button 410 the user turns into client who gets a confirmation 212 about the closed space weather derivative details electronically displayed on the GUI and sent by e-mail. This ends the process 213.

### V. Detailed Example of System Operation

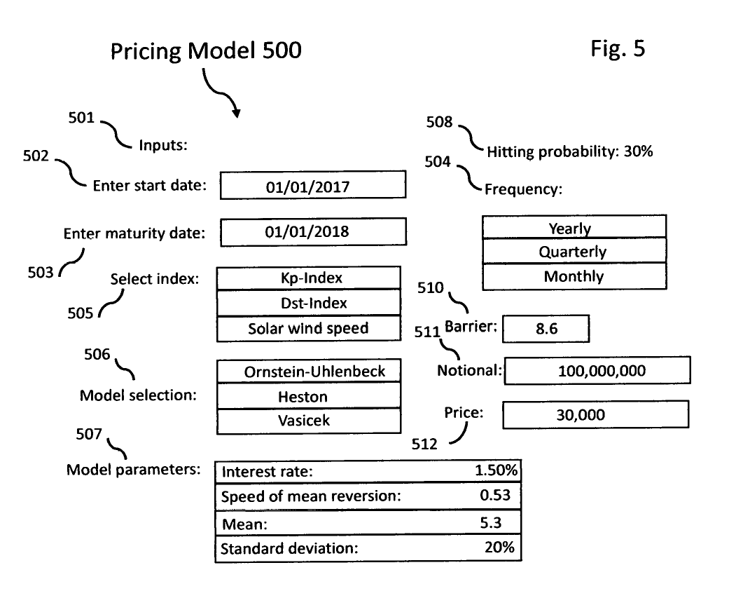

The present invention allows the user 111 to navigate, input and close contracts via a GUI 400 as presented in FIG. 5. The process starts by entering a pre-assigned user identification number (ID) and password 401 on the GUI 400. The user 111 can then choose a recurring or a one-time hedge contract 402. If the user 111 chooses to close a one-time contract then selection process continues by selection of the underlying index 403 subject to hedge. If the user 111 chooses a recurring hedging method, then he needs to choose the frequency 411 by selecting a yearly, quarterly or monthly frequency. The recurrent hedging method ends automatically at the entered maturity 405. By selecting the relevant underlying index 403, the user 111 can choose between the Kp-index 305, Dst-index 306 as well as solar wind speed 307. Next, the user 111 has to choose the model 412 he wants to choose: Ornstein-Uhlenbeck model 509, Heston model 507 or Vasicek 508. The present invention should also encompass all other mean-reverting processes, which can be used to model space weather derivatives. The user 111 has then to enter start date 404 and a maturity date 405, followed by a barrier 406 at which he gets paid out the notional 407 he enters next, if the selected index value 403 reaches the Barrier 406 once between start date 404 and maturity date 405. By clicking the calculate button 408, the pricing server 105 retrieves all relevant historic space weather data from the space weather database 102 and the market database 103 through the pricing server 105 and feeds the selected model 412 with the relevant data. The GUI 400 then returns the price 409 given the current space weather and market conditions. By clicking the hedge button 410 the user 111 agrees to enter into the transaction and becomes hereto a client 114.

### VI. The Pricing Engine

The present invention (i.e., trading system 100 or any part thereof) may be implemented as a cloud based software platform or as a local service. The software (pricing engine) 500 is accessible from any computer system or other processing system. All inputs and inquiries are processed and calculated within the pricing engine 500, and returned on the client's GUI 400. Closed contracts are saved in the price database 104.

Software and data transferred via the work stations 112 and the GUI 400 to the cloud 101 are in the form of signals 113 which may be electronic, electromagnetic, optical or other signals capable of being received by the web server 107. These signals 113 are provided to application interface (API) 106 via the web server 107 (i.e., channel). The web server 107 can be accessible via wire or cable, fiber optics, a phone line, a cellular phone link, an RF link and other communications channels.

In this document, the term “computer program product” refers to cloud based software or a removable storage unit and signals 113 as described in the U.S. patent application No. 6,418, 417 B1, filed: Oct. 8, 2008, entitled “System, Method, And Computer Program Product For Valuating Weather-Based Financial instruments” now allowed and incorporated herein by reference in its entirety.

FIG. 6. shows the pricing model 500 which is embedded in the pricing engine 115. After the user 111 has entered his parameters on the GUI 400, the pricing model 500 is fed with the inputs 501, namely start date 502, maturity 503, frequency 504, index 505, model 506 (Ornstein-Uhlenbeck, Heston or Vasicek model), model parameters 507, it calculates the hitting probability 508 of the barrier 509, specified by the user 111 as well as the price 511 depending on the notional 510, which is also specified by the user 111. If the client confirms the price the price is sent through the pricing server 105 to the price database 104 where it is saved.

### VII Conclusion

The present invention is closely linked to the U.S. patent application No. 6,418, 417 B1, filed: Oct. 8, 2008, entitled “System, Method, And Computer Program Product For Valuating Weather-Based Financial instruments”, but differs in four significant points:

1. Space Weather: although the term weather is included, ‘Space weather’ describes the conditions on the Sun, in the solar wind and the Earth's magneto-, iono- and thermosphere and thus refers to a completely different concept than weather on Earth as referred to in the above-mentioned patent.

2. The underlying index: Instead of referring to a geographical region, the underlying index for calculation of the space weather derivative value is based on index values obtained by measurements of the magnetosphere of the Earth. Therefore, the regional limitation does not apply to the present invention.

3. Determination of derivatives price: Since solar activity exhibits a mean reverting characteristics, the Black Scholes (BS) model does not apply. In order to replicate the mean reverting behavior of geomagnetic activity indices, the mean reverting models such as the Ornstein-Uhlenbeck process, Heston- or Vasicek model need to be applied.

4. Pricing: Instead of pricing plain vanilla Call options, Put options, swaps or other related derivatives based on the BS model, the only possibility to replicate a payout that covers damage caused by solar eruptions, a one-touch Barrier option needs to be priced.

Therefore, the present invention should not be limited by any of the above-described exemplary embodiments or processes, but should be defined only in accordance with the following claims and their equivalents.

What is claimed is:

1. A computer implemented method for valuating a space weather-based financial instrument, wherein said space weather condition is the kp- or dst-index, comprising the steps of:
(1.) receiving information representative of a start date and maturity date for the financial instrument;
(2.) receiving information representative of the Earth's magnetosphere, ionosphere and thermosphere that the financial instrument will derive its value from;
(3.) receiving financial information representative of a risk-free rate;
(4.) receiving historical space weather information, relating to said space weather condition, for said magnetosphere ionosphere and thermosphere during the period between said start date and said maturity date;
(5.) obtaining a value of the financial instrument by applying an Ornstein-Uhlenbeck, Heston or Vasicek process and inverse transformation sampling pricing model using said historical space weather information and said risk-free rate.

2. A system for valuating a space weather-based derivative contract, comprising:
(1.) a space weather history database that stores historical space weather information of the magnetosphere;
(2.) at least one workstation that allows a user to specify inputs that affect the value of the financial instrument;
(3.) at least one trading server, responsive to said workstation and connected to said space weather history database, that obtains a value of the financial instrument by applying a said pricing model using said specified inputs from said user.

3. A computer program product comprising a computer usable or cloud based medium having control logic stored therein for causing a computer or cloud to valuate space weather-based financial instruments, said control logic comprising:
(1.) computer readable program code means for causing the computer or cloud to receive a start date and maturity date for the financial instrument;
(2.) computer readable program code means for causing the computer or cloud to receive magnetospheric data to be covered by the financial instrument;
(3.) computer readable program code means for causing the computer or cloud to receive a space weather condition that he financial instruments will derive its value from;
(4.) computer readable program code means for causing the computer or cloud to receive a risk-free rate;
(5.) computer readable program code means for causing the computer or cloud to access historical space weather information, relating to said space weather condition, for said magnetosphere, ionosphere and thermosphere during the period between said start date and said maturity date;
(6.) computer-readable program code means for causing the computer or cloud to obtain a value of the financial instrument by applying a pricing model using said historical space weather information and said risk-free rate.
